(19) United States
(12) Patent Application Publication
(10) Pub. No.: US 2026/0317471 A1
(43) Pub. Date: Oct. 15, 2026

(54) METHOD FOR PREPARING POLYETHER ESTER POLYOLS AND PRODUCTS THEREOF

(71) Applicant: ZHENGZHOU ZHONGYUAN SPANDEX ENGINEERING TECHNOLOGY CO., LTD, Zhengzhou, Henan Province (CN)

(72) Inventors: Jianqiang QIAO, Zhengzhou (CN); Yuewei CUI, Zhengzhou (CN); Hua ZHOU, Zhengzhou (CN); Jianlin JING, Zhengzhou (CN); Yongqi ZHANG, Zhengzhou (CN); Song TIAN, Zhengzhou (CN); Zhengrong YE, Zhengzhou (CN); Rui LI, Zhengzhou (CN)

(21) Appl. No.: 19/476,141

(22) PCT Filed: Apr. 17, 2024
(86) PCT No.: PCT/CN2024/088284

§ 371 Date: Oct. 16, 2025

(30) Foreign Application Priority Data
Apr. 18, 2023 (CN) 202310424908.4
Apr. 16, 2024 (CN) 202410455754.X

(51) Int. Cl. C08G 18/42; C08G 63/672; D01F 6/70

(52) U.S. Cl. CPC C08G 18/4252; C08G 63/672; D01F 6/70; D10B 2401/061; D10B 2401/063

(57) ABSTRACT

A method for preparing polyether ester polyols and products thereof by adding polyether diols and polyesters as raw materials into a reaction kettle, heating the reaction kettle to the reaction temperature to carry out a transesterification reaction, and distilling off the small-molecule polyols produced in the transesterification reaction by means of vacuum distillation. Among the reaction products, the polyester contains an aromatic dibasic acid polyol ester structure; the polyether diol has a degree of polymerization of 2-20 and a molecular weight of 100-1000; the molar ratio of the aromatic group structure in the polyether diol to that in the polyester is greater than 1.05:1; and the reaction temperature is above the boiling point of the small-molecule polyols and below the boiling point of the polyether diols.

The present invention claims priority to the Chinese invention patent application filed with the China National Intellectual Property Administration on Apr. 18, 2023, with application No. 202310424908.4 and titled “A Method for Preparing Polyether Ester Polyols and Their Products”, and priority to the Chinese invention patent application filed with the China National Intellectual Property Administration on Apr. 16, 2024, with application No. 202410455754.X and titled “An Easily Dyeable Spandex and Its Preparation Method”.

### TECHNICAL FIELD

The present invention relates to the field of methods for preparing polymers and products thereof, and specifically to a method for preparing polyether ester polyols and products thereof.

### BACKGROUND TECHNIQUE

Polyesters are a class of engineering materials with excellent performance and wide applications. In particular, polyesters containing benzene rings in their structures—such as polyethylene terephthalate (PET), polytrimethylene terephthalate (PTT), and polybutylene terephthalate (PBT)—are particularly common. They can be used as fibers, bottles, films, or other plastic products, and have become indispensable plastic varieties in daily life. However, with the increasing use of polyester plastic products, environmental problems caused by non-degradable polyester plastics have attracted growing public attention. Plastic recycling is an effective means to address environmental issues. Currently, the main method for recycling polyester plastics is to remelt and pelletize recycled plastic bottle flakes to produce recycled materials, which are then reprocessed into plastic products. However, this method has high requirements for the quality of recycled plastic bottle flakes: they must have low impurity content, minimal color differences, and small molecular weight variations. Many plastic wastes that do not meet these standards are difficult to recycle and reuse. In addition to recycling and pelletizing, there are methods that involve removing impurities from recycled polyester plastics and then chemically decomposing them into terephthalic acid (PTA) or dimethyl terephthalate (DMT), which are then reused as chemical raw materials. However, this method involves complex processes, makes it difficult to ensure the purity of the resulting products, and limits the applications of the recycled products.

Spandex, short for polyurethane elastic fiber, is currently the most widely used elastic fiber. Spandex is a block copolymer consisting of soft segments and hard segments. The soft segments are generally composed of flexible chain segments, which are typically derived from the reaction of polyols (such as polyethers, polyesters, and hydroxyl-terminated polybutadienes) with polyisocyanates (used to connect the polyols); the hard segments are composed of chain segments with excellent crystallinity, which are generally derived from the reaction of polyisocyanates with small-molecule polyols or small-molecule amine chain extenders. The mainstream spandex on the market is dry-spun polyether-based spandex. The main raw materials for dry-spun polyether-based spandex include polytetrahydrofuran ether diol, diphenylmethane diisocyanate, and amine chain extenders. A polyurethane urea solution is prepared through a two-step polymerization reaction, and necessary additives are then added to form a polyurethane urea spinning dope, which is processed into spandex fibers via duct spinning. This method uses polytetrahydrofuran ether diol as the soft segment, and the resulting spandex fibers have balanced performance-usually high elastic elongation, with a tensile modulus that basically meets the requirements of daily clothing. However, this method has high costs and cannot utilize recycled materials.

In applications, spandex is rarely used as an independent fabric and is often blended with other types of fibers. Currently, the mainstream spandex on the market is polyether-based spandex prepared by dry spinning using polytetrahydrofuran ether diol and diisocyanates as raw materials. Conventional spandex is typically dyed with disperse dyes or acid dyes. However, in practical use, spandex has poor dye uptake and color fastness. After blending with other fibers and undergoing dyeing and finishing, color differences or “white exposure” may occur, significantly affecting the appearance of textile products. The reason lies in the molecular structure of spandex: it mainly consists of less polar polyether segments and more polar polyurethane or polyurethane urea segments. The polyether segment of mainstream spandex products is the residue of polytetrahydrofuran ether diol, which belongs to the amorphous region in the microphase-separated structure. This region has a loose structure, provides elasticity to the spandex fiber, and is the main site for disperse dye uptake—but its binding force with disperse dyes is weak. Theoretically, the polyurethane or polyurethane urea segments can absorb acid, neutral, acid mordant, and disperse dyes through hydrogen bonding and coordination bonding. However, these segments form crystalline regions with tightly packed molecular chains, making it difficult for dye molecules to diffuse into the interior of the crystalline regions, thus greatly reducing dye uptake.

In long-term research, the inventors have found that spandex with high elongation and high elastic recovery can also be prepared using polyether ester polyols with aromatic group-polyether blocks as the soft segment of spandex. Adding a small amount of small-molecule diol structures to the block structure of the above polyether ester polyols can adjust the elastic modulus and elastic recovery rate of spandex. Moreover, the structure of this polyether ester polyol is similar to that of common polyesters, making it possible to use recycled polyesters as raw materials for spandex. Typically, the preparation of such polyether ester polyols involves reacting dicarboxylic acids with aromatic groups with polyether diols. However, the process of preparing terephthalic acid from recycled polyesters is complex, energy-intensive, and difficult to purify.

Therefore, the present invention aims to provide a method for preparing polyether ester polyols suitable for spandex production using recycled polyesters, and a method for preparing easily dyeable spandex using the polyether ester polyols, in order to optimize the production process of the polyether ester polyols and the performance of their products.

### CONTENT OF THE INVENTION

To solve the above problems, the present invention provides a method for preparing polyether ester polyols suitable for spandex production using polyesters as raw materials, the polyether ester polyols prepared by this method, as well as polyurethane elastic fibers, non-woven fabrics, films, and elastomers prepared using the polyether ester polyols, and methods for preparing the same. The specific solutions are as follows: On the one hand, the present invention provides a method for preparing polyether ester polyols, characterized by comprising the following steps:

Step 1) Adding polyether diols and polyesters as raw materials into a reaction kettle, wherein the polyesters contain an aromatic dibasic acid polyol ester structure; the polyether diols have a degree of polymerization of 2-20 and a molecular weight of 100-1000; and the molar ratio of aromatic groups in the polyether diols to those in the polyesters is greater than 1.05:1;

Step 2) Heating the reaction kettle to the reaction temperature to carry out a transesterification reaction, and distilling off the small-molecule polyols produced in the transesterification reaction by means of vacuum distillation to prepare the polyether ester polyols, wherein the reaction temperature is above the boiling point of the small-molecule polyols and below the boiling point of the polyether diols.

In the above method, the “aromatic dibasic acid polyol ester structure” refers to the ester structure in the polyester formed by the reaction of aromatic dibasic acids with polyols. Among them, the “aromatic groups” include aromatic ring structures and heterocyclic aromatic structures. The aromatic rings may be at least one of benzene rings, naphthalene rings, anthracene rings, phenanthrene rings, and other aromatic rings; the heterocyclic aromatic rings may be at least one of pyridine rings, furan rings, thiazole rings, pyrimidine rings, and the like. Specifically, the aromatic dibasic acids may be one or more of terephthalic acid, phthalic acid, isophthalic acid, biphenyldicarboxylic acid, 1,4-naphthalenedicarboxylic acid, 2,6-naphthalenedicarboxylic acid, 2,3-naphthalenedicarboxylic acid, 2,5-furandicarboxylic acid, p-phenylenediacetic acid, m-phenylenediacetic acid, and o-phenylenediacetic acid. The polyols may be one or more of diols, triols, and tetrols-preferably diols, and more preferably one or more of ethylene glycol, 1,3-propanediol, 1,2-propanediol, 1,4-butanediol, 1,6-hexanediol, neopentyl glycol, 2-methyl-1,3-propanediol, and 3-methyl-1,5-pentanediol.

Optionally, the polyesters containing an aromatic dibasic acid polyol ester structure in the present invention may be one or more of polyethylene terephthalate (PET), poly butylene terephthalate (PBT), polytrimethylene terephthalate (PTT), poly(butylene adipate-co-terephthalate) (PBAT), and polyethylene 2,5-furandicarboxylate (PEF). The polyesters containing an aromatic dibasic acid polyol ester structure may also be any other common polyesters containing polyether ester structures or triol/tetrol residue structures—provided that their main chains contain an aromatic dibasic acid polyol ester structure, they can be used as raw materials in the method of the present invention.

Optionally, the polyether diols are homopolymeric or copolymeric polyether diols prepared by the condensation polymerization of C2-C5 small-molecule diols or the ring-opening polymerization of C2-C5 epoxides. Specifically, they are preferably one or more of polyethylene glycol (PEG), poly-1,3-propanediol (P3OG), poly-1,2-propanediol (PPG), polytetrahydrofuran (PTG), polyethylene glycol-1,2-propanediol copolymers, and polytetrahydrofuran-3-methyltetrahydrofuran copolymers.

Optionally, the molar ratio of aromatic group structures in the polyether diols to those in the polyesters is calculated by the following formula:

R=(W+P−36)/(W−A)
wherein,
R is the molar ratio of aromatic group structures in the polyether diols to those in the polyesters;
W is the molecular weight of the target polyether ester polyol, and W is 1000-5000;
P is the molecular weight of the aromatic dibasic acid in the raw materials of the polyester;
A is the average molecular weight of the polyether diol.

Herein, the “aromatic dibasic acid in the raw materials of the polyester” refers to the dibasic acid raw materials that form the aromatic dibasic acid polyol ester structure, such as terephthalic acid, phthalic acid, 2,5-furandicarboxylic acid, and the like as mentioned above.

Polyether ester polyols prepared by the method for preparing polyether ester polyols described above, characterized in that the polyether ester polyols comprise structures represented by the following Formula (1) and Formula (2), and terminal hydroxyl groups:

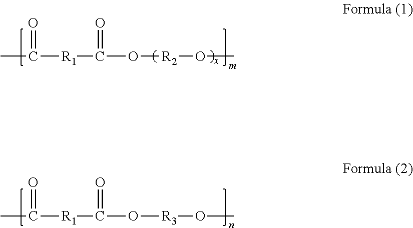

wherein R₁ is an aromatic group structure, and the mass content of R₁ in the repeating unit of Formula (1) is 4.5%-44%; R₂ is at least one of saturated alkyl groups with 2-5 carbon atoms; x is 2-20; R₃ is the residue of the polyol in the polyester raw material;
the mass ratio of Formula (2) in the structure of the polyether ester polyol is less than 20%, preferably less than 10%;
the number-average molecular weight of the polyether ester polyol is 1000-5000; and
the average functionality of the terminal hydroxyl groups is 1.95-2.00.

Preferably, R₂ is at least two of saturated alkyl groups with 2-5 carbon atoms.

The above-mentioned polyether ester polyols can be used not only for preparing spandex but also for preparing other polyurethane-based products. Therefore, the present invention also provides a method for preparing polyurethane elastic fibers, non-woven fabrics, films, or elastomers by means of solution processing or melt processing, using the above-mentioned polyether ester polyols as raw materials. It also provides polyurethane elastic fibers, non-woven fabrics, films, or elastomers prepared by the above method.

On the other hand, the present invention provides an easily dyeable spandex, characterized in that the soft segment in the molecular structure of the easily dyeable spandex comprises repeating units represented by the following Formula (1):

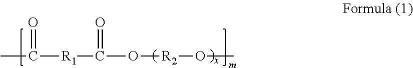

wherein R₁ is an aromatic group structure, and the mass content of R₁ in the repeating unit is 4.5%-44%; R₂ is at least one of straight-chain saturated alkyl groups with 2-3 carbon atoms; x is 2-20; and
the mass proportion of the repeating units represented by Formula (1) in the soft segment of the spandex is more than 2% (preferably more than 5%, more preferably more than 10%) and less than 70% (preferably less than 65%).

Optionally, the soft segment in the molecular structure of the spandex further comprises a polytetramethylene ether segment.

In the present invention, the “mass of the soft segment” refers to the mass of the molecular structure of the part remaining after removing the terminal hydroxyl groups from the reaction product of the diol raw materials (for spandex) and diisocyanates. The “diol raw materials” refer to the diol compounds used as raw materials for the soft segment of the polyurethane molecular weight, including the polyether ester polyols defined in the present invention and optional materials such as polytetrahydrofuran ether diol—but do not include small-molecule diol compounds used as chain extenders. The high-resilience thick-denier spandex can be prepared by dry spinning or melt spinning. Specifically, the preparation methods are as follows:

A method for preparing easily dyeable spandex, characterized by comprising the following steps:
Step 1): Capping diol raw materials with diisocyanate raw materials to prepare a prepolymer;
Step 2): Dissolving the prepolymer with a polar solvent to obtain a prepolymer solution;
Step 3): Carrying out chain extension on the prepolymer using a mixed solution of a chain extender and a terminator to obtain a polyurethane/polyurethane urea solution; Step 4): Adding auxiliaries to prepare a spinning dope; and
Step 5): Preparing the easily dyeable spandex from the prepared spinning dope through spinning equipment.

A method for preparing easily dyeable spandex, characterized by comprising the following steps:
Step a) Adding diisocyanate raw materials, diol raw materials, and small-molecule polyol chain extenders into a reaction vessel respectively;
Step b) Mixing the materials in the reaction vessel, heating the materials during or after mixing to carry out the reaction, and performing extrusion granulation to prepare polyurethane particles; and
Step c) Drying the polyurethane particles, adding auxiliaries, and then performing melt spinning to obtain the easily dyeable spandex.

In one embodiment of the present invention, the diol raw materials include polyether ester polyols with an aromatic group-polyether block structure, and the polyether ester polyols are composed of repeating units represented by Formula (1) and terminal hydroxyl groups:

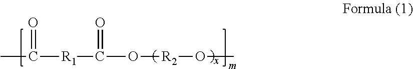

wherein R₁ is an aromatic group structure, and the mass content of R₁ in the repeating unit is 4.5%-44%; R₂ is at least one of straight-chain saturated alkyl groups with 2-3 carbon atoms; x is 2-20 (preferably 3-10); the average functionality of the terminal hydroxyl groups is 1.95-2.00; and the number-average molecular weight of the polyether ester polyol is 800-5000 (preferably 1000-3500, more preferably 1400-2500, and most preferably 1500-2300).

Optionally, the viscosity of the polyether ester polyol at 90° C. and a shear rate of 1 s⁻¹ may be less than 500 poise, preferably less than 200 poise.

Optionally, the mass ratio of the polyether ester polyol in the diol raw materials is more than 2% (preferably more than 5%, more preferably more than 10%) and less than 70% (preferably less than 65%).

Optionally, the diol raw materials further include other diol compounds that can be used as the soft segment of spandex (referred to as “second-type diol raw materials”), such as polyether diols (e.g., polytetrahydrofuran ether diol, polyethylene glycol, polypropylene glycol), polyester diols (e.g., polybutylene adipate diol, copolyester diols of adipic acid and mixed diols such as ethylene glycol/1,4-butanediol, ethylene glycol/1,2-propanediol, 1,6-hexanediol/2,2-dimethyl-1,3-propanediol), other polyether ester diols that can be used as the soft segment of spandex, or a mixture of at least two of the above diol compounds.

Preferably, the mass of the second-type diol raw materials accounts for 30%-95% of the total diol raw materials. That is, in a preferred scheme, the polyether ester polyols and the second-type diol raw materials are blended to serve as the diol raw materials for spandex.

The preferred second-type diol raw material is furan ether diol.

In another embodiment of the present invention, the diol raw materials include polyether ester polyols with an aromatic group-polyether block structure, and the polyether ester polyols comprise repeating units represented by Formula (1) and terminal hydroxyl groups:

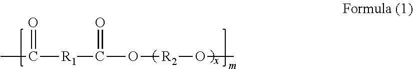

wherein R₁ is an aromatic group structure, and the mass content of R₁ in the repeating unit is 4.5%-44%; R₂ is at least one of straight-chain saturated alkyl groups with 2-3 carbon atoms; x is 2-20 (preferably 3-10); the mass percentage of the repeating units represented by Formula (1) in the polyether ester polyol is more than 5%; the average functionality of the terminal hydroxyl groups is 1.95-2.00; and the number-average molecular weight of the polyether ester polyol is 800-5000 (preferably 1000-3500, more preferably 1400-2500, and most preferably 1500-2300).

The polyether ester polyols may contain other polyester structures, polyether structures, or aliphatic structures serving as modified structures.

Similarly, the above-mentioned polyether ester polyols can be blended with the aforementioned second-type diol raw materials to serve as the diol raw materials for spandex.

### Beneficial Effects

The method for preparing polyether ester polyols provided by the present invention uses polyesters as raw materials, enabling direct processing of recycled polyesters into polyether ester polyols suitable for spandex production. This simplifies the production process of polyether ester polyols for spandex, utilizes recycled resources, and expands the source of raw materials for polyurethane elastic fibers.

Meanwhile, the easily dyeable spandex provided by the present invention incorporates polyether ester polyols with a specific structure into the diol raw materials, resulting in spandex fibers whose molecular soft segments contain specific aromatic group-polyether block structures—thus preparing easily dyeable spandex. Compared with conventional spandex, the easily dyeable spandex of the present invention can improve the dye uptake and color fixing ability of spandex for disperse dyes and acid dyes without losing the mechanical properties of spandex.

By adjusting the mass ratio of the above-mentioned aromatic group-polyether block structures in the molecular soft segments of spandex, the spandex achieves sufficient dye uptake and color fixing rate while maintaining good alkali resistance.

### Specific Embodiments

For the recycling of polyester materials, the most common methods currently include melt pelletization recycling, or chemical decomposition into terephthalic acid (PTA) or dimethyl terephthalate (DMT) for reuse as chemical raw materials. The present invention discloses a method for preparing polyether ester polyols using polyester as the raw material, in which the prepared polyether ester polyols can serve as the soft segment raw material for spandex. Through the method of the present invention, polyester can be directly used as a raw material for polyurethane elastic fibers, which not only expands the application of recycled polyester but also broadens the source of raw materials for spandex.

Specifically, the present invention provides a method for preparing polyether ester polyols and the polyether ester polyols prepared by this method. The polyether ester polyols comprise the structures represented by the following Formula (1) and Formula (2), as well as terminal hydroxyl groups:

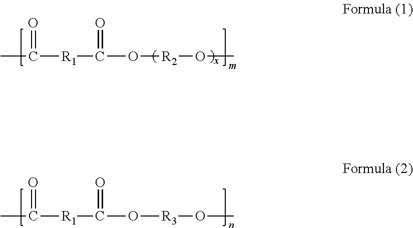

wherein R₁ is an aromatic group structure, and the mass content of R₁ in the repeating unit of Formula (1) is 4.5%-44%; R₂ is at least one of saturated alkyl groups with 2-5 carbon atoms; x is 2-20; R₃ is the residue of the polyol in the polyester raw material;
the mass ratio of Formula (2) in the structure of the polyether ester polyol is less than 20%, preferably less than 10%, and more preferably 0;
the number-average molecular weight of the polyether ester polyol is 1000-5000; and
the average functionality of the terminal hydroxyl groups is 1.95-2.00.

Hereinafter, unless otherwise specified, “polyether ester polyols” specifically refer to those with the above characteristics.

The “aromatic group structures” in the present invention include aromatic rings and heterocyclic aromatic rings. The aromatic rings may be at least one of benzene rings, naphthalene rings, anthracene rings, phenanthrene rings, and other aromatic rings. The heterocyclic aromatic rings may be at least one of pyridine rings, furan rings, thiazole rings, pyrimidine rings, and the like. If the content of the aromatic group R₁ in the polyether ester polyol is too high, the resulting polyether ester polyol will have excessively high rigidity, which in turn leads to excessively high viscosity and hinders the production process of polyurethane elastic fibers. Therefore, the mass content of R₁ in the repeating unit of Formula (1) is limited to 4.5%-44%.

The structure of Formula (2) is the residual structure of unreacted polyester in the method of the present invention. Since the reaction of the present invention cannot be 100% complete in practice, a portion of the group structure of the polyester raw material will remain, so the finally prepared polyether ester polyol may contain a portion of the structural units of Formula (2) mentioned above. However, through the control of reaction conditions, the transesterification reaction can be made as complete as possible. The structure of Formula (2) will significantly increase the melting point of the polyether ester polyol and also enhance the intermolecular forces of the polyether ester diol, leading to excessively high viscosity of the prepolymer during prepolymerization and making the prepolymerization reaction impossible to complete. In addition, the aromatic dibasic acid polyol ester structure will also affect the elastic recovery of the final polyurethane, resulting in a lower elastic recovery rate and increased permanent deformation. Therefore, in the present invention, the mass ratio of Formula (2) in the structure of the polyether ester polyol is less than 20%, preferably less than 10%, and more preferably 0.

According to the present invention, the average functionality of the terminal hydroxyl groups of the polyether ester polyol can be 1.95-2.00, preferably 1.96-2.00, and more preferably 1.98-2.00. This ensures that the polyether ester polyol can be smoothly capped with isocyanates and subsequently chain-extended with small-molecule amines or alcohols. If the average functionality is greater than 2.00, when the polyether ester polyol is used as a raw material for preparing polyurethane, the resulting polyurethane may have a cross-linked structure, making it impossible to form linear polyurethane; such polyurethane will form gels during continuous production, hindering the continuous production of spandex. If the average functionality is too low, the molecular weight of the prepared polyurethane will also be low, thereby affecting the performance of the polyurethane elastic fiber. In actual reactions, due to the possible dehydration of terminal hydroxyl groups to form double bonds during the condensation polymerization/ring-opening polymerization of the polyether diol, and the limitations of the actual reaction effect, the polycondensation or transesterification reaction of the polyether diol to form the polyether ester polyol cannot be 100% complete. Therefore, the average functionality of the finally prepared polyether ester polyol generally cannot reach 2.00.

Herein, “average functionality” refers to the average number of hydroxyl groups per mole of polyether ester polyol that can participate in the reaction. In the present invention, considering the formation of double bonds due to the dehydration of terminal hydroxyl groups of the polyether diol and the presence of unreacted carboxyl groups, the average functionality of hydroxyl groups can be calculated by the following formula:

Functionality=2×Moles of hydroxyl groups/(Moles of hydroxyl groups+Moles of carboxyl groups+Moles of double bonds)

The melting point of the polyether ester polyol of the present invention can be lower than 80° C., and it is preferably liquid at room temperature. This prevents it from solidifying during storage or transportation, ensuring the realization of industrial continuous operations. Otherwise, it would be necessary to heat it to melt, increasing energy consumption.

The inventors have found that the polyether ester polyols with the above characteristics can replace polytetrahydrofuran ether diol as the soft segment raw material for spandex, and the prepared spandex has a high elastic recovery rate. On this basis, the inventors propose a method for preparing the above-mentioned polyether ester polyols. Compared with the conventional method of reacting dicarboxylic acids with polyether diols, the method of the present invention can use recycled polyester as the raw material to prepare the polyether ester polyols, which broadens the utilization method of recycled polyester, expands the source of raw materials for spandex, and is more in line with the concept of environmental protection.

The specific preparation method of the polyether ester polyols proposed by the present invention includes the following steps:
Step 1) Add polyether diols and polyesters as raw materials into a reaction kettle, where the polyesters contain an aromatic dibasic acid polyol ester structure; the polyether diols have a degree of polymerization of 2-20, preferably 3-10, and a molecular weight of 100-1000; the molar ratio of aromatic groups in the polyether diols to those in the polyesters is greater than 1.05:1; and
Step 2) Heat the reaction kettle to the reaction temperature for transesterification reaction, and distill off the small-molecule polyols produced by the transesterification reaction through vacuum distillation to prepare polyether ester polyols, with the reaction temperature being above the boiling point of the small-molecule polyols and below the boiling point of the polyether diols.

In the method of the present invention, transesterification reaction is carried out using polyesters with aromatic group structures and specific polyether diols as raw materials to prepare polyether ester polyols that meet the above-mentioned characteristics. The target molecular structure of the polyether ester polyols prepared by the present invention is an aromatic group-polyether structure connected by ester bonds. Therefore, the above method selects polyesters containing aromatic group structures as raw materials to introduce the aromatic group structures in the polyesters into the molecular structure of the polyether ester polyols. Specifically, the polyesters containing aromatic group structures can be any common polyester materials copolymerized from aromatic groups and small-molecule polyols, such as polyethylene terephthalate (PET), polytrimethylene terephthalate (PTT), polybutylene terephthalate (PBT), poly (butylene adipate-co-terephthalate) (PBAT) with aromatic acid ester structures; or polyesters with aromatic heterocyclic acid ester structures, such as polyethylene 2,5-furandicarboxylate (PEF). All the above-mentioned polyesters can be obtained from recycled polyester plastic bottles, polyester fibers, polyester films, etc. Compared with rigid aromatic group structures, the polyether segments in the polyether ester polyols of the present invention provide elasticity to the molecules. To ensure the finally prepared spandex has sufficient elastic recovery ability, the polyether segments should have a certain length. If the length of the polyether segments is too short, the viscosity of the polyether ester polyols will be too high, which is not conducive to the continuous large-scale production process of spandex and will lead to poor elastic recovery performance of spandex. If the length of the polyether segments is too long, the elastic modulus of spandex will be too poor. Therefore, in the present invention, the polyether diols used as raw materials for polyether segments preferably have a degree of polymerization of 2-20, more preferably 3-10, and a molecular weight of 100-1000, preferably 300-1000, more preferably 600-900. Specifically, the polyether diols can be synthesized by ring-opening polymerization of epoxy monomers or condensation polymerization of small-molecule diols, and they can be homopolymers synthesized from a single monomer or copolymers synthesized from two or more monomers.

For example, the polyether diols suitable for the present invention can be one or more of diethylene glycol (DEG), triethylene glycol (TEG), polyethylene glycol (PEG), poly-1,3-propanediol (P3OG), polypropylene glycol (PPG), polytetrahydrofuran (PTG), or copolymer diols obtained by the reaction of tetrahydrofuran with monomers such as ethylene oxide, propylene oxide, 2-methyltetrahydrofuran or 3-methyltetrahydrofuran.

The number-average molecular weight of the polyether ester polyols of the present invention should be 1000-5000, preferably 1000-3500, more preferably 1400-2500, and most preferably 1500-2300. The larger the number-average molecular weight of the polyether ester polyols, the higher their viscosity, making it difficult to carry out continuous operations on an industrial scale. However, if the molecular weight of the polyether ester polyols is too small, when the molecular weight requirement of the polyurethane prepolymer is consistent, more diisocyanates are needed to participate in the synthesis, resulting in a high content of urethane groups in the prepolymer, thus enhancing the interaction between prepolymer molecules and increasing the viscosity. Moreover, the length of the soft segments in the formed polyurethane is short at this time, which will affect the recovery performance of the final polyurethane elastic fiber. In a preferred embodiment, the viscosity of the polyether ester polyols of the present invention at 90° C. and a shear rate of 1 s⁻¹ can be less than 500 poise, preferably less than 200 poise.

Since the method provided by the present invention prepares polyether ester polyols by carrying out transesterification reaction between polyesters containing aromatic groups and polyether diols, the molecular weight of the polyether ester polyols can be adjusted by adjusting the molar ratio R of aromatic groups in the polyether diols to those in the polyesters. Hereinafter, the molar ratio R all refers to the molar ratio of aromatic groups in the polyether diols to those in the polyesters. The higher the above-mentioned molar ratio R (i.e., the higher the proportion of polyether diols in the raw materials), the more terminal hydroxyl groups remain after the small-molecule polyol residues in the polyester polymer are replaced by polyether diols, and thus the smaller the number-average molecular weight of the prepared polyether ester polyols. On the contrary, the lower the proportion of polyether diols in the raw materials, the larger the number-average molecular weight of the prepared polyether ester polyols. To adjust the molecular weight of the polyether ester polyols, the number of moles of polyether diols should be greater than that of the aromatic group structures in the polyesters. Theoretically, when the transesterification reaction is complete, the polyether diols will replace all small-molecule polyol residues in the polyesters, and the excess polyether diols will cleave the macromolecular polyester chains to form polyether ester polyols with relatively small molecular weights. Therefore, the difference between the number of moles of polyether diols and the number of moles of aromatic group structures in the polyesters is the number of moles of the finally obtained polyether ester polyols. Based on the above analysis, the calculation method for the theoretical expected molecular weight of the finally prepared polyether ester polyols is as follows:

$$\frac{\begin{matrix}Mass of fed polyether diols + Mass of fed \\ polyesters - Mass of small - molecule polyols \\ produced in transesterification reaction\end{matrix}}{\begin{matrix}Number of moles of fed polyether diols - Number \\ of moles of aromatic group structures in polyesters\end{matrix}} \qquad Formula ( 3 )$$

The specific molar ratio R of aromatic groups in the polyether diols to those in the polyesters can be derived by reversing the above formula, and the specific process is as follows:

Let the molecular weight of the finally obtained polyether ester polyol be W, the molecular weight of the polyether diol be A, and the number of moles of the fed polyether diol be M; then the mass of the fed polyether diol is M·A. Assuming the polyester is obtained by the reaction of an aromatic dibasic acid with a molecular weight of P and a small-molecule polyol with a molecular weight of Q, then the molecular weight of the polyester repeating unit is (P+Q−36), the number of moles of aromatic group structures in the fed polyester is M/R, and the mass of the fed polyester is (P+Q−36)·M/R. Substituting the above letters into Formula (1), the following formula is obtained:

$$W = \frac{MA + ( P + Q - 36 ) \cdot M / R}{M - M / R} \qquad Formula ( 4 )$$

Simplifying the above Formula (4), the relationship between the molecular weight W of the polyether ester polyol and the fed molar ratio R is obtained as follows:

$$W = \frac{RA + P - 36}{R - 1} \qquad Formula ( 5 )$$

Through Formula (5), when it is necessary to prepare a polyether ester polyol with a specific molecular weight, the fed molar ratio R can be calculated by the following formula:

$$R = \frac{W + P - 36}{W - A} \qquad Formula ( 6 )$$

It can be seen from Formula (6) that to prepare a polyether ester polyol with a molecular weight W of 1000-5000, in addition to the molar ratio R, it is also related to the molecular weight P of the aromatic dibasic acid and the molecular weight A of the polyether diol. However, it is certain that the number of moles of polyether diols in Step (1) should be greater than that of aromatic groups in the polyesters. Therefore, in the present invention, the molar ratio of aromatic groups in the polyether diols to those in the polyesters is greater than 1.05:1, preferably greater than 1.1:1.

In Step (2), the temperature of the transesterification reaction should be controlled above the boiling point of the small-molecule polyols and below the boiling point of the polyether diols. This can distill off the exchanged small-molecule polyols as much as possible and promote the complete progress of the transesterification.

During the transesterification reaction, a catalyst is preferably added to promote the reaction. In the present invention, the catalyst is selected from one or more of titanium, vanadium, tin, antimony, zirconium, bismuth and rare earth catalysts; preferably, it is selected from one or more of tetrapropyl titanate, tetrabutyl titanate, dibutyltin dilaurate, stannous octoate and bismuth laurate.

The present invention also provides a method for preparing polyurethane products such as polyurethane elastic fibers, non-woven fabrics, films, or elastomers using the aforementioned polyether ester polyols or those prepared by the aforementioned method as raw materials. The polyurethane can be prepared by either a two-step method involving prepolymer synthesis or a one-pot method with all materials added together.

The two-step method for preparing polyurethane includes the following steps: (1) reacting polyether ester polyols with diisocyanates to form a prepolymer; and (2) polymerizing the prepolymer with a chain extender and a chain terminator. The one-pot method for preparing polyurethane includes the following steps: (1) separately feeding polyether ester polyols, diisocyanates, and small-molecule polyol chain extenders, i.e., adding each material into the reaction vessel separately; and (2) mixing the polyether ester polyols, diisocyanates, and small-molecule polyol chain extenders in the reaction vessel, and heating the mixture to carry out the reaction, or heating during the mixing process. The diisocyanates can be selected from one or more of diphenylmethane diisocyanate, toluene diisocyanate, isophorone diisocyanate, hexamethylene diisocyanate, dicyclohexylmethane diisocyanate, and their isomers. Chain extenders can be amine-based or alcohol-based. Among them, amine-based chain extenders can be diamines with 2-30 carbon atoms, for example, selected from one or more of ethylenediamine, propylenediamine, pentylenediamine, methylpentylenediamine, methylpropylenediamine, hexamethylenediamine, triethylenediamine, xylylenediamine, phenylenediamine, diaminocyclohexane, hexamethylenediamine, and dopamine. Alcohol-based chain extenders can be one or more of common chain extenders such as ethylene glycol, 1,4-butanediol, diethylene glycol, 1,6-hexanediol, 1,3-propanediol, and 1,4-dimethylolcyclohexane. Chain terminators can be monoamines with 2-20 carbon atoms, selected from one or more of ethylamine, isopropylamine, n-butylamine, tert-butylamine, hexylamine, dimethylamine, diethylamine, dipropylamine, di-n-butylamine, di-tert-butylamine, diisobutylamine, diisopropylamine, cyclohexylamine, or ethanolamine.

Unless otherwise specified in this specification, the corresponding operating conditions in existing methods for preparing polyurethane products such as polyurethane elastic fibers, non-woven fabrics, films, and elastomers using polyether diols (e.g., solution processing or melt processing) are all applicable to the present invention. For example, polyurethane elastic fibers can be prepared by dry spinning of polyurethane solutions (using methods and equipment described in Patent Document CN1147628C) or melt spinning of polyurethane chips (using the melt spinning method described in Patent Document CN1180137C); non-woven fabrics can be processed by methods such as melt blowing or solution electrospinning (specifically, the melt-blown non-woven fabric manufacturing method described in Patent Document CN101400838A and non-woven fabrics prepared by the solution electrospinning method described in Patent Document JP2009108422A); polyurethane films can be processed by methods such as solution casting, dip coating, melt extrusion, film blowing, or casting (specifically, the casting method described in Patent Document JP2005205787A, the dip coating method described in Patent Document WO2015064776A1, the extrusion method described in Patent Document GB1137520A, the film blowing method described in Patent Document DE2239478A1, and the casting method described in Patent Document JP2004203933A); and elastomers can be processed by methods such as extrusion, injection molding, or casting (specifically, the extrusion method described in Patent Document JP1996027376A, the injection molding method described in Patent Document U.S. Pat. No. 3,917,792A, and the casting method described in Patent Document CA1251294A). The production methods of polyurethane products described in the above patent documents are all incorporated into the present invention. The above preparation methods for polyurethane elastic fibers, non-woven fabrics, films, and elastomers are merely examples. In addition to the aforementioned forms, the polyether ester polyols of the present invention can be used as diol raw materials to produce polyurethane products through any existing technology or means.

Furthermore, the present invention provides an easily dyeable spandex prepared using the aforementioned polyether ester polyols and a preparation method thereof. The easily dyeable spandex has good dye uptake and color fixing ability for disperse dyes and acid dyes. The soft segment in the molecular structure of the easily dyeable spandex comprises repeating units represented by the following Formula (1):

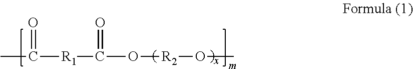

wherein R₁ is an aromatic group structure, and the mass content of R₁ in the repeating unit is 4.5%-44%; R₂ is at least one of straight-chain saturated alkyl groups with 2-3 carbon atoms; and x is 2-20;
the mass proportion of the repeating units represented by Formula (1) in the soft segment is more than 5%, preferably more than 10%.

Optionally, the soft segment in the molecular structure of the spandex further includes a polytetramethylene ether segment.

Since dyeing with disperse dyes and acid dyes is performed in aqueous solutions, dye molecules are completely dissolved in water. Ordinary spandex yarns use polytetrahydrofuran as the diol raw material, resulting in hydrophobic polyurethane urea polymers. The molecular structure of the easily dyeable spandex provided by the present invention includes the aforementioned Formula (1) structure, where (R₂—O)ₓ increases the hydrophilicity of the molecular chain. This structure is introduced into the spandex molecular structure through polyether ester polyols prepared from PEG and P3OG (polyethylene glycol and poly-1,3-propanediol, especially polyethylene glycol) with aromatic dibasic acids. Compared with polytetrahydrofuran, the above structure has a higher density of ether oxygen bonds. Polyurethane urea polymers prepared using this polyether ester polyol have stronger hydrophilicity, making the spandex more easily swollen by dye solutions during acid dyeing and disperse dyeing, increasing intermolecular gaps and allowing dye molecules to more easily enter the interior of spandex filaments. In addition, since most acid dye molecules and disperse dye molecules are macromolecules containing aromatic rings, the aromatic ring structure introduced by the polyether ester polyol has stronger van der Waals forces with dye molecules. This makes dye molecules entering the spandex interior have stronger interactions with the polyether ester polyol, being more easily fixed within spandex molecules, thus exhibiting higher dye uptake and color fixing rates for acid and disperse dyeing.

While meeting the requirements for dye uptake and color fixing rate, the introduction of the Formula (1) structure should avoid affecting the mechanical properties of spandex as much as possible. Therefore, the present invention imposes more specific requirements on the Formula (1) structure as described above.

Considering the dye uptake and color fixing rate of spandex, R₂ in the Formula (1) repeating unit contained in the soft segment of the easily dyeable spandex molecular structure is preferably a straight-chain saturated alkyl group with 2-3 carbon atoms. For easily dyeable spandex, fewer carbon atoms in R₂ result in higher ether oxygen bond density, enhancing water absorption of the spandex, facilitating dye molecule penetration into spandex fibers, and improving dye uptake. Branched molecular structures adversely affect water absorption. Therefore, R₂ in the present invention is preferably a straight-chain saturated alkyl group. Specifically, (R₂—O)ₓ can be the polyether segment of PEG, P3OG, or a copolymer ether of ethylene glycol and 1,3-propanediol, with the straight-chain saturated alkyl group containing 2 carbon atoms being most preferred.

In the molecular structure of the easily dyeable spandex of the present invention, the structure represented by Formula (1) must account for a certain proportion in the soft segment to improve the dye uptake and color fixing rate of the spandex towards dyes. In the present invention, the mass proportion of the structure represented by Formula (1) in the soft segment shall be more than 2%, preferably more than 5%, more preferably more than 10%, even more preferably more than 30%, and most preferably more than 50%.

The polyether ester structure represented by Formula (1) has little impact on the mechanical properties of spandex, so its mass proportion in the soft segment can be appropriately increased. However, due to the presence of ester groups in this structure, the alkali resistance of the spandex containing this structure is inferior to that of spandex prepared from polytetrahydrofuran ether diol, and there may be a loss of mechanical properties during the dyeing and finishing process. Therefore, the mass proportion of the polyether ester structure represented by Formula (1) in the spandex soft segment should not be too high, preferably less than 80%, more preferably less than 70%, and even more preferably less than 65%. Specifically, spandex prepared from polyether ester polyols and spandex prepared from polyether polyols can be blended in the form of raw materials, prepolymers, or polymers to improve the alkali resistance of the spandex prepared from polyether ester polyols.

The present invention also provides a method for preparing the aforementioned easily dyeable spandex. The easily dyeable spandex can be prepared by dry spinning or melt spinning, wherein the dry spinning includes the following steps:
Step 1): Capping diol raw materials with diisocyanate raw materials to prepare a prepolymer;
Step 2): Dissolving the prepolymer with a polar solvent to obtain a prepolymer solution;
Step 3): Carrying out chain extension of the prepolymer using a mixed solution of a chain extender and a terminator to obtain a polyurethane/polyurethane urea solution;
Step 4): Adding auxiliaries to prepare a spinning dope; and
Step 5): Preparing the easily dyeable spandex from the prepared spinning dope through spinning equipment.

Compared with the conventional dry spinning of spandex, the improvement of the scheme of the present invention mainly lies in the change of diol raw materials.

In one embodiment of the present invention, the diol raw materials include polyether ester polyols with an aromatic group-polyether block structure, and the polyether ester polyols are composed of repeating units represented by Formula (1) and terminal hydroxyl groups:

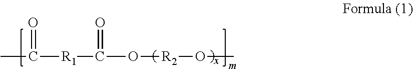

wherein R₁ is at least one of aromatic rings and heterocyclic aromatic rings, and the mass content of R₁ in the repeating unit is 4.5%-44%; R₂ is at least one of straight-chain saturated alkyl groups with 2-3 carbon atoms; x is 2-20 (preferably 3-10); the average functionality of the terminal hydroxyl groups is 1.95-2.00; and the number-average molecular weight of the polyether ester polyols is 800-5000, preferably 1000-3500, more preferably 1400-2500, and most preferably 1500-2300.

Optionally, the viscosity of the polyether ester polyols at 90° C. and a shear rate of 1 s⁻¹ can be less than 500 poise, preferably less than 200 poise.

In addition to the preparation method described earlier in the present invention, the polyether ester polyols can also be prepared by condensation reaction or transesterification between aromatic dibasic acids, their esters, or their anhydrides and polyether diols. In one embodiment, the esters can be obtained by the reaction of aromatic dibasic acids with monohydric alcohols with a boiling point lower than 150° C. (such as small-molecule alcohols like methanol, ethanol, n-butanol, and n-hexanol). Thus, they can be easily removed by distillation in the subsequent esterification or transesterification reaction. The small-molecule alcohols are preferably methanol or ethanol. Moreover, compared with aromatic dibasic acids, the transesterification between the above esters and polyether diols can be carried out under milder reaction conditions, which is beneficial to the design of the production process.

To ensure that dye molecules can more easily enter the interior of the spandex yarn, the polyether diols are preferably at least one of straight-chain saturated alkyl groups with 2-3 carbon atoms. The high-density ether oxygen bonds can make the polyether segments have stronger hydrophilicity, so that during acid dyeing and disperse dyeing, the spandex is more easily swollen by the dye solution, the gaps between molecules become larger, and dye molecules can more easily enter the interior of the spandex yarn. Specifically, the polyether diols can be polyethylene glycol (PEG), poly-1,3-propanediol (P3OG), or copolymer ether diols of ethylene glycol and 1,3-propanediol. Preferably, the polyether diols are polyethylene glycol (PEG), which has a higher density of ether oxygen bonds and can endow the spandex with better hydrophilicity, thereby facilitating the entry of dye molecules into the interior of the spandex yarn.

The aromatic dibasic acids can be selected from one or more of terephthalic acid, isophthalic acid, phthalic acid, biphenyldicarboxylic acid, 1,4-naphthalenedicarboxylic acid, 2,6-naphthalenedicarboxylic acid, 2,3-naphthalenedicarboxylic acid, 2,5-furandicarboxylic acid, terephthalic diacetic acid, isophthalic diacetic acid, and phthalic diacetic acid. Since most acid dye molecules and disperse dye molecules are macromolecules containing aromatic rings, the aromatic ring structures introduced by the polyether ester polyols have stronger van der Waals forces with the dye molecules, enabling the dye molecules entering the spandex to have stronger interactions with the polyether ester segments and be more easily fixed within the spandex molecules. Therefore, under the combined action of the polyether segments and aromatic ring structures, spandex with polyether-aromatic ring structures exhibits better dye uptake and color fixing rates compared to conventional spandex.

By using the polyether ester polyols containing aromatic group-polyether block structures as raw materials for the soft segments of spandex, the structure represented by Formula (1) can be introduced into the molecular structure of the spandex.

In the aforementioned polyether ester polyols, due to the presence of ester groups, using such polyether ester polyols exclusively as diol raw materials for spandex results in spandex with inferior alkali resistance compared to polyether-based spandex. Therefore, it is necessary to limit the mass ratio of the aromatic group-polyether block structures in the soft segments of the spandex. A specific method for controlling this mass ratio involves blending spandex prepared from polyether ester polyols with spandex prepared from polyether polyols in the form of diol raw materials, prepolymers, or polymers to improve the alkali resistance of the spandex prepared from polyether ester polyols.

Taking the blending of diol raw materials for spandex as an example, to ensure the spandex has better dye uptake and color fixing rates, the mass ratio of the polyether ester polyols in the diol raw materials should be more than 2%, preferably more than 5%, more preferably more than 10%, even more preferably more than 20%, still more preferably more than 30%, yet more preferably more than 40%, and most preferably more than 50%.

To ensure the alkali resistance of the prepared spandex, the mass ratio of the polyether ester polyols in the diol raw materials should be less than 80%, preferably less than 70%, and more preferably less than 65%.

Optionally, in addition to the aforementioned polyether ester polyols, the diol raw materials may include other diol compounds that can serve as soft segments of spandex, as the second type of diol raw materials. Examples include polyether diols such as polytetrahydrofuran ether diol, polyethylene glycol, and polypropylene glycol; polyester diols such as polybutylene adipate diol and copolyester diols of adipic acid and mixed diols (e.g., ethylene glycol/1,4-butanediol, ethylene glycol/1,2-propanediol, 1,6-hexanediol/2,2-dimethylpropanediol-1,3); other polyether ester diols that can serve as soft segments of spandex; or mixtures of at least two of the aforementioned diol compounds. To ensure the alkali resistance of the spandex, polyether diols are preferred as the second type of diol raw materials, with polytetrahydrofuran ether diol being most preferred. The mass proportion of the second type of diol raw materials in all diol raw materials is preferably 30%-98%, more preferably 35%-90%. That is, the preferred scheme involves blending the polyether ester polyols with the second type of diol raw materials as the diol raw materials for spandex.

The methods involving blending of prepolymers or polymers are similar to those described above and will not be repeated here.

To ensure the alkali resistance of the prepared spandex, in another embodiment of the present invention, the diol raw materials include polyether ester polyols with aromatic group-polyether block structures, and the polyether ester polyols contain repeating units represented by Formula (1) and terminal hydroxyl groups:

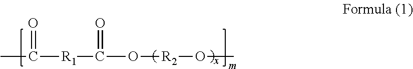

wherein R₁ is at least one of aromatic rings and heterocyclic aromatic rings, and the mass content of R₁ in the repeating unit is 4.5%-44%; R₂ is at least one of straight-chain saturated alkyl groups with 2-3 carbon atoms; x is 2-20 (preferably 3-10); the mass percentage of the repeating units represented by Formula (1) in the polyether ester polyols is more than 2%, preferably more than 5%, more preferably more than 10%; the average functionality of the terminal hydroxyl groups is 1.95-2.00; and the number-average molecular weight of the polyether ester polyols is 800-5000, preferably 1000-3500, more preferably 1400-2500, and most preferably 1500-2300.

Unlike the previous embodiment, which involves blending polyether ester polyols with the second type of diol raw materials, this embodiment chooses to reduce the proportion of the cyclic structure in Formula (1) within the polyether ester polyols. To balance the dyeing performance and alkali resistance of the spandex, in the preferred embodiment, the mass ratio of the cyclic structure in Formula (1) within the polyether ester polyols should be more than 5%, preferably more than 10%, more preferably more than 30%, and most preferably more than 50%. Meanwhile, it is preferably less than 80%, more preferably less than 70%, and even more preferably less than 65%. The remaining portion of the polyether ester polyols may contain other polyester structures, polyether structures, or aliphatic structures as modified structures. To ensure the mechanical properties of the spandex, polyether structures are preferred, with polytetramethylene ether structures being most preferred.

Similarly, the aforementioned polyether ester polyols can be blended with the second type of diol raw materials described earlier as the diol raw materials for spandex.

In the preparation method of the easily dyeable spandex according to the present invention, the diisocyanate raw material in Step 1) can be one or more of diphenylmethane diisocyanate, toluene diisocyanate, isophorone diisocyanate, hexamethylene diisocyanate, dicyclohexylmethane diisocyanate, and their isomers.

The polar solvent in Step 2) is at least one of N,N-dimethylformamide (DMF) and N,N-dimethylacetamide (DMAc).

The chain extender in Step 3) can be an amine-based or alcohol-based chain extender. Among them, the amine-based chain extender can be a diamine with 2-30 carbon atoms, for example, selected from one or more of ethylenediamine, propylenediamine, butylenediamine, pentylenediamine, methylpentylenediamine, methylpropylenediamine, hexamethylenediamine, triethylenediamine, xylylenediamine, phenylenediamine, diaminocyclohexane, hexamethylenediamine, and dopamine; the alcohol-based chain extender can be one or more of common chain extenders such as ethylene glycol, 1,4-butanediol, diethylene glycol, 1,6-hexanediol, 1,3-propanediol, and 1,4-dimethylolcyclohexane. The chain terminator can be a monoamine with 2-20 carbon atoms, selected from one or more of ethylamine, isopropylamine, n-butylamine, tert-butylamine, hexylamine, dimethylamine, diethylamine, dipropylamine, di-n-butylamine, di-tert-butylamine, diisobutylamine, diisopropylamine, cyclohexylamine, or ethanolamine.

The melt spinning process includes the following steps:
Step a) Adding the diisocyanate raw material, diol raw material, and small-molecule polyol chain extender into a reaction vessel respectively;
Step b) Mixing the materials in the reaction vessel, heating the materials to carry out the reaction during or after mixing, and extruding and pelletizing to obtain polyurethane pellets; and
Step c) Drying the polyurethane pellets, adding auxiliaries, and then performing melt spinning.

The raw materials for preparing spandex by the above melt spinning (such as diisocyanates and diol raw materials) are similar to those for dry spinning, with the difference that only alcohol-based chain extenders are used as the chain extender in Step a).

### EMBODIMENTS

The present invention is described in more detail below through examples, where the testing methods for the involved parameters are as follows:

1. Average functionality:

Functionality=2*moles of hydroxyl groups/(moles of hydroxyl groups+moles of carboxyl groups+moles of double bonds).

Herein, the acid value is measured by the method described in HG/T 2708-1995; the hydroxyl value is measured by the method described in HG/T 2709-1995; and the unsaturation degree is measured by the method described in GB/T 12008.6-2010. The corresponding acid value, hydroxyl value, and unsaturation degree are converted into the moles of the corresponding end groups in the polyether ester diol.

2. 300% tensile stress, breaking strength, and elongation at break: All are measured in accordance with the “Textile Industry Standard of the People's Republic of China” FZ/T 50006-2013, “Test Method for Tensile Properties of Spandex Filament”.
3. Plastic deformation test:

One end of the prepared sample is clamped into the upper holder, and a pre-tension is applied to the other end to straighten the sample axially before clamping it into the lower holder. The instrument is then started.

The sample is stretched from 0% elongation (L0) to 300% elongation (L1) at a speed of 500 mm/min, then recovered to 0% elongation. This stretch-recovery cycle is repeated four times. During the fifth stretch to 300% elongation, the force value F1 at 200% elongation is recorded. After a 30-second delay, the sample is recovered to 0% elongation, during which the force value F2 at 200% elongation during recovery is recorded. After another 30-second delay, a sixth stretch is performed, and the length L2 of the sample at the pre-tension position is recorded.

Formula for plastic deformation rate:(L2−L0)/L0*100%

wherein:
“5LP200%” refers to the stress value at 200% elongation during the 5th stretch, i.e., F1; “5UP200%” refers to the rebound stress value when recovering from 300% elongation to 200% elongation in the 5th cycle, i.e., F2, which can characterize the recovery modulus; and
“Plastic deformation rate” refers to the ratio of the spandex length increase to the original length after 5 stretches; “5UP200%/5LP200%” refers to the ratio of the 200% recovery stress to the 200% stretch stress in the 5th cycle of the 5-stretch cycle test.
4.Dye uptake of acid dyes and color fastness after soaping:
In the present invention, acid red is used as the acid dye. The dye concentration in the dye bath before dyeing is measured as A, the dye concentration in the dye bath after dyeing as B, and the dye concentration in the soaping liquor after soaping as C. The results are calculated as follows:

Acid dye uptake=(A−B)/A

Acid dye color fastness after soaping=(A−B−C)/A

5.Dye uptake of disperse dyes and color fastness after soaping:
In the present invention, disperse orange is used as the spinning dye. The dye concentration in the dye bath before dyeing is measured as P, the dye concentration in the dye bath after dyeing as Q, and the dye concentration in the soaping liquor after soaping as M. The results are calculated as follows:

Disperse dye uptake=(P−Q)/P

Disperse dye color fastness after soaping=(P−Q−M)/P

6.Alkali resistance test of spandex filament:

The spandex filament is boiled in a 10 g/L potassium hydroxide solution at 100° C. for 1 hour, and the mechanical properties before and after boiling in the alkali solution are tested.

In addition, the antioxidant mentioned in the following examples is antioxidant 245, the dyeing assistant is DH300R or 2462B, and the light stabilizer is Tinuvin 791, all of which are commercially available substances.

In the following examples, due to the influence of small-molecule polyols distilled out as non-condensable gases during the reaction and the volatilization of small-molecule components in polyether diols, the actual alcohol-acid ratio involved in the reaction is lower than the theoretical value. Therefore, the molecular weight of the final product will be larger than the theoretical value, but the deviation is within an acceptable range.

Embodiments 1-6 below relate to the preparation of polyether ester polyols using polyethylene terephthalate (PET) as a raw material.

### Embodiment 1: Preparation of Polyether Ester Polyol with a Molecular Weight of 1200

First, polyethylene terephthalate was crushed. 2081.9 g of crushed polyethylene terephthalate (PET) and 3000 g of polyethylene glycol with a number-average molecular weight of 200 (PEG200) were added into the reaction kettle (i.e., the molar ratio was about 1.38). 3 g of zinc acetate and 1.5 g of Sb₂O₃ were added as catalysts. The temperature was gradually raised to 235° C. to start the transesterification reaction, and maintained at 235° C. until the reaction system became homogeneous. Vacuum distillation was used to distill out ethylene glycol from the reaction system until the amount of distilled ethylene glycol was close to the theoretical value, and 650 g of ethylene glycol was distilled out from the reaction system. A polyether ester polyol with a molecular weight of 1200 was obtained. The viscosity of the polyether ester polyol at 40° C. and 1 S⁻¹ was 100 Poise, the acid value was 0.3, and it was a light yellow liquid at room temperature.

### Embodiment 2: Preparation of Polyether Ester Polyol with a Molecular Weight of 2100

First, polyethylene terephthalate was crushed. 2428.9 g of crushed polyethylene terephthalate (PET) and 3000 g of polyethylene glycol with a number-average molecular weight of 200 (PEG200) were added into the reaction kettle (i.e., the molar ratio was about 1.19). 3 g of magnesium acetate and 1.5 g of Sb₂O₃ were added as catalysts. The temperature was gradually raised to 235° C. to start the transesterification reaction, and maintained at 235° C. until the reaction system became homogeneous. Vacuum distillation was used to distill out ethylene glycol from the reaction system until the amount of distilled ethylene glycol was close to the theoretical value, and 781.9 g of ethylene glycol was distilled out from the reaction system. A polyether ester polyol with a molecular weight of 2100 was obtained. The viscosity of the polyether ester polyol at 40° C. and 1 S⁻¹ was 210 Poise, the acid value was 0.3, and it was a light yellow liquid at room temperature.

### Embodiment 3: Preparation of Polyether Ester Polyol with a Molecular Weight of 3400

First, polyethylene terephthalate was crushed. 2602.4 g of crushed polyethylene terephthalate (PET) and 3000 g of polyethylene glycol with a number-average molecular weight of 200 (PEG200) were added into the reaction kettle (i.e., the molar ratio was about 1.11). 3 g of zinc acetate and 1.5 g of Sb₂O₃ were added as catalysts. The temperature was gradually raised to 235° C. to start the transesterification reaction, and maintained at 235° C. until the reaction system became homogeneous. Vacuum distillation was used to distill out ethylene glycol from the reaction system until the amount of distilled ethylene glycol was close to the theoretical value, and 842.3 g of ethylene glycol was distilled out from the reaction system. A polyether ester polyol with a molecular weight of 3400 was obtained. The viscosity of the polyether ester polyol at 40° C. and 1 S⁻¹ was 650 Poise, the acid value was 0.3, and it was a light yellow liquid at room temperature.

### Embodiment 4: Preparation of Polyether Ester Polyol with a Molecular Weight of 1500

First, polyethylene terephthalate was crushed. 1296.5 g of crushed polyethylene terephthalate (PET) and 4203 g of polyethylene glycol with a number-average molecular weight of 400 (PEG400) were added into the reaction kettle (i.e., the molar ratio was about 1.57). 3 g of zinc acetate and 1.5 g of Sb₂O₃ were added as catalysts. The temperature was gradually raised to 245° C. to start the transesterification reaction, and maintained at 245° C. until the reaction system became homogeneous. Vacuum distillation was used to distill out ethylene glycol from the reaction system until the amount of distilled ethylene glycol was close to the theoretical value, and 418.6 g of ethylene glycol was distilled out from the reaction system. A polyether ester polyol with a molecular weight of 1500 was obtained. The viscosity of the polyether ester polyol at 40° C. and 1 S⁻¹ was 73.5 Poise, the acid value was 0.3, and it was a light yellow liquid at room temperature.

### Embodiment 5: Preparation of Polyether Ester Polyol with a Molecular Weight of 3450

First, polyethylene terephthalate was crushed. 1019.2 g of crushed polyethylene terephthalate (PET) and 4480 g of polyethylene glycol with a number-average molecular weight of 650 (PTG650) were added into the reaction kettle (i.e., the molar ratio was about 1.30). 3 g of zinc acetate and 1.5 g of Sb₂O₃ were added as catalysts. The temperature was gradually raised to 245° C. to start the transesterification reaction, and maintained at 245° C. until the reaction system became homogeneous. Vacuum distillation was used to distill out ethylene glycol from the reaction system until the amount of distilled ethylene glycol was close to the theoretical value, and 329 g of ethylene glycol was distilled out from the reaction system. A polyether ester polyol with a molecular weight of 3450 was obtained. The viscosity of the polyether ester polyol at 40° C. and 1 S⁻¹ was 35.2 Poise, the acid value was 0.3, and it was a light yellow liquid at room temperature.

### Embodiment 6: Preparation of Polyether Ester Polyol with a Molecular Weight of 3500

First, polyethylene terephthalate was crushed. 699 g of crushed polyethylene terephthalate (PET) and 4800.2 g of poly-1,3-propanediol with a number-average molecular weight of 1000 (P3OG1000) were added into the reaction kettle (i.e., the molar ratio was about 1.32). 3 g of zinc acetate and 1.5 g of Sb₂O₃ were added as catalysts. The temperature was gradually raised to 250° C. to start the transesterification reaction, and maintained at 250° C. until the reaction system became homogeneous. Vacuum distillation was used to distill out ethylene glycol from the reaction system until the amount of distilled ethylene glycol was close to the theoretical value, and 286 g of ethylene glycol was distilled out from the reaction system. A polyether ester polyol with a molecular weight of 3500 was obtained. The viscosity of the polyether ester polyol at 40° C. and 1 S⁻¹ was 28.5 Poise, the acid value was 0.3, and it was a light yellow liquid at room temperature.

### Embodiment 7: Preparation of Polyether Ester Polyol with a Molecular Weight of 3480

First, polybutylene terephthalate was crushed. 1137.14 g of crushed polybutylene terephthalate (PBT) and 4362.85 g of polytetrahydrofuran with a number-average molecular weight of 650 (PTG650) were added into the reaction kettle (i.e., the molar ratio was about 1.30). 3 g of zinc acetate and 1.5 g of Sb₂O₃ were added as catalysts. The temperature was gradually raised to 260° C. to start the transesterification reaction, and maintained at 260° C. until the reaction system became homogeneous. Vacuum distillation was used to distill out ethylene glycol from the reaction system until the amount of distilled ethylene glycol was close to the theoretical value, and 465 g of butanediol was distilled out from the reaction system. A polyether ester polyol with a molecular weight of 3480 was obtained. The viscosity of the polyether ester polyol at 40° C. and 1 S⁻¹ was 35.8 Poise, the acid value was 0.3, and it was a light yellow liquid at room temperature.

Embodiments 8-10 below relate to the use of polyether ester polyols for preparing polyurethane elastic fibers.

### Embodiment 8: Use of the Polyether Ester Polyol from Embodiment 1 for Preparing Polyurethane Elastic Fibers

100 kg of the polyether ester polyol prepared in Embodiment 1 was added into a reaction kettle preheated to 45° C. Stirring was started at a speed of 150 rpm, and 31 kg of diphenylmethane diisocyanate was added. After stirring for 5 minutes, the temperature was raised to 90° C. The reaction was carried out at 90° C. for 2 hours to obtain a prepolymer.

The prepolymer was cooled to 50° C., and 166.72 kg of dimethylacetamide (DMAc) was used to dissolve the prepolymer. Then, an amine solution containing 2.40 kg of ethylenediamine and 0.29 kg of diethylamine with a mass concentration of 3.2% was added, and the stirring speed was increased to 300 rpm for chain extension reaction. After the chain extension reaction was completed, necessary additives such as antioxidants and dyeing assistants were added, and the mixture was aged for 30 hours to obtain a spinning dope with a solid content of 35%. The above dope was subjected to dry spinning to obtain a polyurethane elastic fiber PUU-3 with a denier of 40D.

### Embodiment 9: Use of the Polyether Ester Polyol from Embodiment 6 for Preparing Polyurethane Elastic Fibers

100 kg of the polyether ester polyol prepared in Embodiment 1 was added into a reaction kettle preheated to 45° C. Stirring was started at a speed of 150 rpm, and 16.15 kg of diphenylmethane diisocyanate was added. After stirring for 5 minutes, the temperature was raised to 90° C. The reaction was carried out at 90° C. for 2 hours to obtain a prepolymer.

The prepolymer was cooled to 50° C., and 147.82 kg of dimethylacetamide (DMAc) was used to dissolve the prepolymer. Then, an amine solution containing 2.13 kg of ethylenediamine and 0.26 kg of diethylamine with a mass concentration of 3.2% was added, and the stirring speed was increased to 300 rpm for chain extension reaction. After the chain extension reaction was completed, necessary additives such as antioxidants and dyeing assistants were added, and the mixture was aged for 30 hours to obtain a spinning dope with a solid content of 35%. The above dope was subjected to dry spinning to obtain a polyurethane elastic fiber PUU-4 with a denier of 40D.

### Embodiment 10: Use of the Polyether Ester Polyol from Embodiment 7 for Preparing Polyurethane Elastic Fibers

100 kg of the polyether ester polyol prepared in Embodiment 1 was added into a reaction kettle preheated to 45° C. Stirring was turned on at a speed of 150 rpm, and 16.20 kg of diphenylmethane diisocyanate was added. After stirring for 5 minutes, the temperature was raised to 90° C. The reaction was carried out at 90° C. for 2 hours to obtain a prepolymer.

The prepolymer was cooled to 50° C., and 147.89 kg of dimethylacetamide (DMAc) was used to dissolve the prepolymer. Then, an amine solution with a mass concentration of 3.2%, containing 2.14 kg of ethylenediamine and 0.27 kg of diethylamine, was added, and the stirring speed was increased to 300 rpm to carry out the chain extension reaction. After the completion of the chain extension reaction, necessary additives such as antioxidants and dyeing assistants were added, followed by aging for 30 hours to obtain a spinning dope with a solid content of 35%. The above dope was subjected to dry spinning to obtain a polyurethane elastic fiber PUU-5 with a denier of 40D.

### Comparative Example 1: Use of Polytetrahydrofuran (PTMG) with a Number-Average Molecular Weight of 2000 for Preparing Polyurethane Elastic Fibers

100 kg of polytetrahydrofuran PTMG2000 (with a number-average molecular weight of 2000) was added into a reaction kettle preheated to 45° C. Stirring was turned on at a speed of 150 rpm. 22.2 kg of diphenylmethane diisocyanate was added, and after stirring for 5 minutes, the temperature was raised to 90° C. The reaction was carried out at 90° C. for 2 hours to obtain a prepolymer.

The prepolymer was cooled to 50° C., and 155.5 kg of dimethylacetamide (DMAc) was used to dissolve the prepolymer. Then, an amine solution with a concentration of 3.2%, containing 2.26 kg of ethylenediamine and 0.28 kg of diethylamine, was added, and the stirring speed was increased to 300 rpm to carry out the chain extension reaction. After the completion of the chain extension reaction, necessary additives such as antioxidants and dyeing assistants were added, followed by aging for 30 hours to obtain a spinning dope with a solid content of 35%. The above dope was subjected to dry spinning to obtain a polyurethane elastic fiber PUU-0 with a denier of 40D.

### Comparative Example 2: Use of Polyethylene Glycol with a Number-Average Molecular Weight of 1500 for Preparing Polyurethane Elastic Fibers

100 kg of polyethylene glycol with a number-average molecular weight of 1500 was added into a reaction kettle preheated to 45° C. Stirring was turned on at a speed of 150 rpm. 26.5 kg of diphenylmethane diisocyanate was added, and after stirring for 5 minutes, the temperature was raised to 90° C. The reaction was carried out at 90° C. for 2 hours to obtain a prepolymer.

The prepolymer was cooled to 50° C., and 161 kg of dimethylacetamide (DMAc) was used to dissolve the prepolymer. Then, an amine solution with a concentration of 3.2%, containing 2.32 kg of ethylenediamine and 0.28 kg of diethylamine, was added, and the stirring speed was increased to 300 rpm to carry out the chain extension reaction. After the completion of the chain extension reaction, necessary additives such as antioxidants and dyeing assistants were added, followed by aging for 30 hours to obtain a spinning dope with a solid content of 35%. The above dope was subjected to dry spinning to obtain a polyurethane elastic fiber PUU-1 with a denier of 40D.

### Comparative Example 3: Use of Polypropylene Glycol with a Number-Average Molecular Weight of 2000 for Preparing Polyurethane Elastic Fibers

100 kg of polypropylene glycol with a number-average molecular weight of 2000 was added into a reaction kettle preheated to 45° C. Stirring was turned on at a speed of 150 rpm. 21.98 kg of diphenylmethane diisocyanate was added, and after stirring for 5 minutes, the temperature was raised to 90° C. The reaction was carried out at 90° C. for 2 hours to obtain a prepolymer.

The prepolymer was cooled to 50° C., and 155.24 kg of dimethylacetamide (DMAc) was used to dissolve the prepolymer. Then, an amine solution with a concentration of 3.2%, containing 2.24 kg of ethylenediamine and 0.28 kg of diethylamine, was added, and the stirring speed was increased to 300 rpm to carry out the chain extension reaction. After the completion of the chain extension reaction, necessary additives such as antioxidants and dyeing assistants were added, followed by aging for 30 hours to obtain a spinning dope with a solid content of 35%. The above dope was subjected to dry spinning to obtain a polyurethane elastic fiber PUU-2 with a denier of 40D.

### Comparative Example 4: Preparation of Polyether Ester Polyol with a Molecular Weight of 1200

First, polyethylene terephthalate was crushed. 2602.4 g of crushed polyethylene terephthalate (PET) and 3000 g of polyethylene glycol (PEG200) with a number-average molecular weight of 200 were added into a reaction kettle. 3 g of zinc acetate and 1.5 g of Sb₂O₃ were added as catalysts, and the temperature was gradually raised to 235° C. to start the transesterification reaction. The temperature was maintained at 235° C. until the reaction system became homogeneous, and vacuum distillation was used to distill out ethylene glycol from the reaction system, with 681 g of ethylene glycol distilled out from the reaction system. A polyether ester diol with a molecular weight of 1200 was obtained. This polyether ester diol was a solid at 40° C., with a melting point of 60° C. and an acid value of 0.3. The molar proportion of its ethylene glycol ester structure was 20%.

### Comparative Example 5: Use of the Polyether Ester Polyol from Comparative Example 4 for Preparing Polyurethane Elastic Fibers

100 kg of the polyether ester polyol prepared in Comparative Example 4 was added into a reaction kettle preheated to 90° C. Stirring was turned on at a speed of 150 rpm, and 31 kg of diphenylmethane diisocyanate was added to start the prepolymerization reaction. When the reaction proceeded for 57 minutes, the viscosity of the prepolymer became too high, making it impossible to continue the prepolymerization reaction.

According to the above test method, the following parameters of the polyurethane elastic fibers (i.e., spandex filaments) obtained in Examples 8, 9, 10 and Comparative Examples 1, 2, 3 were tested, and the test results are summarized in the table below.

| | Tensile | | | | | | |
|---|---|---|---|---|---|---|---|
| | stress at | | | | | | |
| | 300% | | Elonga- | | | | |
| | elonga- | Breaking | tion at | | | Plastic | |
| Spandex | tion, | Strength, | break, | 5LP200%, | 5UP200%, | Deformation | 5UP200%/ |
| filament | cN | cN | % | cN | cN | Rate, % | 5LP200% |
| PUU-0 | 12.08 | 45.31 | 550 | 1.88 | 1.22 | 31.35 | 64.4% |
| PUU-1 | 6.22 | 12.12 | 417 | 1.02 | 0.75 | 63.52 | 73.5% |
| PPU-2 | 8.9 | 25.2 | 703 | 0.91 | 0.72 | 30.1 | 79.1% |
| PUU-3 | 15.21 | 38.98 | 515 | 2.22 | 1.83 | 27.3 | 82.4% |
| PUU-4 | 9.24 | 40.37 | 682 | 1.60 | 1.26 | 23.1 | 78.8% |
| PUU-5 | 10.08 | 40.91 | 623 | 1.57 | 1.28 | 22.9 | 81.5% |

It can be seen from the data in the above table that, compared with the polyurethane elastic fibers prepared from polyethylene glycol as the raw material, the polyurethane elastic fibers prepared by using the polyether ester polyol of the present invention have significantly improved tensile stress and breaking strength, which are close to or even exceed those of the polyurethane elastic fibers conventionally prepared from polytetrahydrofuran ether diol, and can meet the performance requirements of spandex filaments for clothing. In addition, the plastic deformation rate of the polyurethane elastic fibers prepared by using the polyether ester polyol of the present invention is significantly reduced. From the perspective of the 5UP200% value, the polyurethane elastic fibers using the polyether ester diol of the present invention have a higher 5UP200% recovery stress, i.e., a higher recovery modulus, which indicates a greater resilience and can improve the shape retention of fabrics. In conclusion, the preparation method of the polyether ester polyol provided by the present invention can use post-consumer polyester as the raw material to prepare a polyether ester polyol raw material for spandex, whose performance is comparable to that of the existing polytetrahydrofuran. The spandex prepared from this raw material has performance similar to that of spandex prepared from polytetrahydrofuran, with good mechanical properties and effectively improved wearing performance. Therefore, the polyether ester polyol prepared by the method for preparing polyether ester polyol from polyester provided by the present invention can be used as a soft segment raw material for spandex, which broadens the application approaches of recycled polyester materials and also expands the raw material sources of spandex.

The spinning dopes in Examples 8, 9, 10 and Comparative Examples 1, 2, 3 were diluted from a solid content of 35% to a solid content of 20%, and then polyurethane film gloves were prepared by dip-coating. The corresponding example film samples PUU-F3, PUU-F4, PUU-F5 and comparative example film samples PUU-F0, PUU-F1, PUU-F2 were obtained by cutting. The specific preparation steps of the film samples are as follows:

First, the hand mold was slowly immersed into the tank containing the diluted dope, then slowly lifted out of the dope tank. The hand mold was rotated slowly to make the dope have a uniform thickness on the surface of the hand mold, and then the hand mold was dried in an oven. After drying, the gloves were stripped off to obtain polyurethane film gloves with a wall thickness of about 150 microns. To test the mechanical properties of the glove films, the film from the palm part of the glove was cut into samples with a width of 6 mm and a length of 10 cm, and the mechanical properties were tested.

The mechanical properties are as follows:

| | Tensile | | | | | | |
|---|---|---|---|---|---|---|---|
| | stress at | | | | | | |
| | 300% | Breaking | Elongation | | | Plastic | |
| Film | elongation, | Strength, | at break, | 5LP200%, | 5UP200%, | Deformation | 5UP200%/ |
| strip | N | N | % | N | N | Rate, % | 5LP200% |
| PUU- | 2.23 | 15.56 | 1151 | 1.13 | 0.73 | 23.75 | 64.6% |
| F0 | | | | | | | |
| PUU- | 1.22 | 5.03 | 861 | 0.30 | 0. 22 | 64.2 | 73. 3% |
| F1 | | | | | | | |
| PUU- | 1.68 | 8.42 | 1379 | 0.41 | 0. 32 | 32.5 | 78% |
| F2 | | | | | | | |
| PUU- | 2.80 | 14. 12 | 1095 | 1.33 | 1.10 | 17.33 | 83.2% |
| F3 | | | | | | | |
| PUU- | 4.42 | 14.38 | 1350 | 0.96 | 0.78 | 16.28 | 81. 8% |
| F4 | | | | | | | |
| PUU- | 1.22 | 14.52 | 1308 | 0.93 | 0.76 | 17. 09 | 82. 5% |
| F5 | | | | | | | |

It can be seen from the data in the above table that for the film product gloves prepared by using the polyether ester polyol of the present invention, the test of the film pieces cut from their palms shows that compared with the thin-walled product film pieces prepared from polyethylene glycol and polypropylene glycol as raw materials, the tensile stress and breaking strength are significantly improved, which are close to or exceed the mechanical properties of the film products prepared from polytetrahydrofuran, and can meet the mechanical property requirements of elastic film gloves. This is consistent with the phenomenon observed in spandex filaments. At the same time, the polyurethane film gloves prepared by using the polyether ester diol of the present invention have the characteristic of low plastic deformation, which makes the shape of the film glove products more stable. From the perspective of the 5UP200% value, the polyurethane film pieces prepared by using the polyether ester diol of the present invention have a higher 5UP200% recovery force, which means better wrapping property of the gloves. At the same time, on the premise of ensuring the wrapping force, the gloves can be made thinner, thereby reducing the raw material cost of the film gloves. The polyether ester polyol provided by the present invention effectively improves the mechanical properties of the film pieces when the polyether ester polyol is used as the soft segment of the polyurethane film fibers. On this basis, it also enables the thin-walled glove film products to have a lower plastic deformation rate and a higher recovery modulus, which is beneficial to the shape retention of the film glove products, improves the wrapping property of the film glove products, and can reduce the raw material production cost.

### Embodiment 11: Melt-Spun Spandex Prepared from the Polyether Ester Polyol of Embodiment 2

The polyether ester polyol of Embodiment 2, 1,4-butanediol, and diphenylmethane diisocyanate were respectively metered into a twin-screw extruder at a molar ratio of 1.2:2:3.2. Continuous polymerization reaction and extrusion were carried out at 195° C., followed by underwater pelletizing. After drying until the moisture content of the polyurethane pellets was lower than 100 ppm, necessary additives such as antioxidants and light stabilizers were added for melt spinning together, resulting in spandex TPU-1 with a denier of 20D.

### Comparative Example 6: Melt-Spun Spandex Prepared from Polytetrahydrofuran with a Number-Average Molecular Weight of 2000

Polytetrahydrofuran PTMG2000 (with a number-average molecular weight of 2000), 1,4-butanediol, and diphenylmethane diisocyanate were respectively metered into a twin-screw extruder at a molar ratio of 1.2:2:3.2. Continuous polymerization reaction and extrusion were carried out at 190° C., followed by underwater pelletizing. After drying until the moisture content of the polyurethane pellets was lower than 100 ppm, necessary additives such as antioxidants and light stabilizers were added for melt spinning together, resulting in TPU-0 with a denier of 20D.

### Comparative Example 7: Melt-Spun Spandex Prepared from Polyethylene Glycol with a Number-Average Molecular Weight of 1500

Polyethylene glycol with a number-average molecular weight of 1500, 1,4-butanediol, and diphenylmethane diisocyanate were respectively metered into a twin-screw extruder at a molar ratio of 1.2:2:3.2. Continuous polymerization reaction and extrusion were carried out at 190° C., followed by underwater pelletizing. After drying until the moisture content of the polyurethane pellets was lower than 100 ppm, necessary additives such as antioxidants and light stabilizers were added for melt spinning together, resulting in TPU-2 with a denier of 20D.

| | Tensile | | | | | | |
|---|---|---|---|---|---|---|---|
| | stress at | | | | | | |
| | 300% | Breaking | Elongation | | | Plastic | |
| Spandex | elongation, | Strength, | at break, | 5LP200%, | 5UP200%, | Deformation | 5UP200%/ |
| filament | cN | cN | % | cN | cN | Rate, % | 5LP200% |
| TPU-0 | 13.5 | 45 | 540 | 1.775 | 1.14 | 32.8 | 64.5% |
| TPU-1 | 17.5 | 43 | 485 | 2.21 | 1.77 | 28.2 | 82. 4% |
| TPU-2 | 5.8 | 11.5 | 416 | 0.986 | 0.712 | 38.2 | 72. 3% |

From the comparison of mechanical properties between the above comparative examples and embodiments, it can be seen that the melt-spun spandex filaments processed in melt form using polyether ester as raw material have significantly higher tensile stress and recovery modulus than those processed in melt form using polytetrahydrofuran as raw material, exhibiting similar mechanical property characteristics and advantages to dry-spun spandex processed in solvent form.

In the following content, Embodiments 12-18 serve as dyeability tests for the dyeable spandex provided by the present invention.

### Embodiment 12: Polyether Ester Polyol with a Number-Average Molecular Weight of 1500 Prepared from Polyethylene Glycol (with a Number-Average Molecular Weight of 600) and Terephthalic Acid

17 parts by weight of polyethylene glycol PEG600 (with a number-average molecular weight of 600) and 2.7 parts by weight of terephthalic acid were put into a reaction kettle, and nitrogen gas was introduced to replace the air inside the reaction kettle. Stirring inside the reaction kettle was started at a speed of 150 rpm. The system was heated up programmatically: first heated to 150° C. and maintained for 5 hours, then further heated to 230° C., and this temperature was maintained until the water yield of the system reached more than 90% of the theoretical value and the solution became homogeneous. Tetraisopropyl titanate was added as a catalyst, and the pressure was gradually reduced to 2000 Pa by vacuum pumping. When the acid value was lower than 0.5 mgKOH/g, a polyether ester polyol with a number-average molecular weight of 1500 was obtained. Tests showed that its average functionality was 1.98, the viscosity at 90° C. and 1 S⁻¹ was 25 Poise, and it was a liquid at room temperature.

For the consideration of polyester recycling, the polyether ester polyol with a number-average molecular weight of 1500 in this embodiment can also be prepared by using PEG600 and crushed PET as raw materials, in a manner similar to that of Embodiments 1-6.

### Embodiment 13: Use of the Polyether Ester Polyol from Embodiment 12 for Preparing Polyurethane Elastic Fibers

100 kg of the polyether ester polyol prepared in Embodiment 1 was added into a reaction kettle preheated to 45° C. Stirring was started at a speed of 150 rpm, and 31 kg of diphenylmethane diisocyanate was added. After stirring for 5 minutes, the temperature was raised to 90° C. The reaction was carried out at 90° C. for 2 hours to obtain a prepolymer.

The prepolymer was cooled to 50° C., and 166.72 kg of dimethylacetamide (DMAc) was used to dissolve the prepolymer. Then, an amine solution with a mass concentration of 3.2%, containing 2.40 kg of ethylenediamine and 0.29 kg of diethylamine, was added, and the stirring speed was increased to 300 rpm to carry out the chain extension reaction. After the completion of the chain extension reaction, necessary additives such as antioxidants and dyeing assistants were added, followed by aging for 30 hours to obtain a spinning dope with a solid content of 35%. The above dope was subjected to dry spinning to obtain a polyurethane elastic fiber PUU-6 with a denier of 40D.

### Embodiment 14: Use of the Polyether Ester Polyol from Embodiment 12 and Polytetrahydrofuran (PTMG) with a Number-Average Molecular Weight of 2000 for Preparing Polyurethane Fibers

50 kg of the polyether ester polyol prepared in Embodiment 1 and 50 kg of polytetrahydrofuran with a number-average molecular weight of 2000 were added into a reaction kettle preheated to 45° C. Stirring was started at a speed of 150 rpm, and 21.88 kg of diphenylmethane diisocyanate was added. After stirring for 5 minutes, the temperature was raised to 90° C. The reaction was carried out at 90° C. for 2 hours to obtain a prepolymer.

The prepolymer was cooled to 50° C., and 161.3 kg of dimethylacetamide (DMAc) was used to dissolve the prepolymer. Then, an amine solution with a mass concentration of 3.26%, containing 2.38 kg of ethylenediamine and 0.29 kg of diethylamine, was added, and the stirring speed was increased to 300 rpm to carry out the chain extension reaction. After the completion of the chain extension reaction, necessary additives such as antioxidants and dyeing assistants were added (the addition amount of dyeing assistant 2462B was 1%), followed by aging for 30 hours to obtain a spinning dope with a solid content of 35%. The above dope was subjected to dry spinning to obtain a polyurethane elastic fiber PUU-7 with a denier of 40D.

### Embodiment 15: Use of Prepolymers Prepared from the Polyether Ester Polyol of Embodiment 12 and Polytetrahydrofuran (PTMG) with a Number-Average Molecular Weight of 2000 for Preparing Polyurethane Fibers

50 kg of the polyether ester polyol prepared in Embodiment 1 was added into a reaction kettle preheated to 45° C. Stirring was started at a speed of 150 rpm, and 15.64 kg of diphenylmethane diisocyanate was added. After stirring for 5 minutes, the temperature was raised to 90° C. The reaction was carried out at 90° C. for 2 hours to obtain Prepolymer 1.

50 kg of polytetrahydrofuran with a number-average molecular weight of 2000 was added into a reaction kettle preheated to 45° C. Stirring was started at a speed of 150 rpm, and 11.1 kg of diphenylmethane diisocyanate was added. After stirring for 5 minutes, the temperature was raised to 90° C. The reaction was carried out at 90° C. for 2 hours to obtain Prepolymer 2.

Prepolymer 1 and Prepolymer 2 were cooled to 50° C. and transferred into the same reaction kettle. 161.3 kg of dimethylacetamide (DMAc) was used to dissolve the prepolymers, and then an amine solution with a mass concentration of 3.26%, containing 2.38 kg of ethylenediamine and 0.29 kg of diethylamine, was added. The stirring speed was increased to 300 rpm to carry out the chain extension reaction. After the completion of the chain extension reaction, necessary additives such as antioxidants and dyeing assistants were added (the addition amount of dyeing assistant 2462B was 1%), followed by aging for 30 hours to obtain a spinning dope with a solid content of 35%. The above dope was subjected to dry spinning to obtain a polyurethane elastic fiber PUU-8 with a denier of 40D.

### Embodiment 16: Use of a Blended Dope (Prepared by Blending 100 kg of the Dope from Embodiment 13 and 100 kg of the Dope from Comparative Example 1) for Preparing Polyurethane Fibers

100 kg of the dope prepared in Embodiment 13 and 100 kg of the dope prepared in Comparative Example 1 were taken and mixed uniformly by means of stirring in a reaction kettle combined with static mixing. The above blended dope was subjected to dry spinning to obtain a polyurethane elastic fiber PUU-9 with a denier of 40D.

### Embodiment 17: Use of the Polyether Ester Polyol from Embodiment 12 and Polytetrahydrofuran (PTMG) with a Number-Average Molecular Weight of 2000 for Preparing Polyurethane Fibers

10 kg of the polyether ester polyol prepared in Embodiment 12 and 90 kg of polytetrahydrofuran with a number-average molecular weight of 2000 were added into a reaction kettle preheated to 45° C. Stirring was started at a speed of 150 rpm, and 21.88 kg of diphenylmethane diisocyanate was added. After stirring for 5 minutes, the temperature was raised to 90° C. The reaction was carried out at 90° C. for 2 hours to obtain a prepolymer.

The prepolymer was cooled to 50° C., and 161.3 kg of dimethylacetamide (DMAc) was used to dissolve the prepolymer. Then, an amine solution with a mass concentration of 3.26%, containing 2.38 kg of ethylenediamine and 0.29 kg of diethylamine, was added, and the stirring speed was increased to 300 rpm to carry out the chain extension reaction. After the completion of the chain extension reaction, necessary additives such as antioxidants and dyeing assistants were added (the addition amount of dyeing assistant 2462B was 1%), followed by aging for 30 hours to obtain a spinning dope with a solid content of 35%. The above dope was subjected to dry spinning to obtain a polyurethane elastic fiber PUU-10 with a denier of 40D.

### Embodiment 18: Use of the Polyether Ester Polyol from Embodiment 12 and Polytetrahydrofuran (PTMG) with a Number-Average Molecular Weight of 2000 for Preparing Polyurethane Fibers

65 kg of the polyether ester polyol prepared in Embodiment 12 and 35 kg of polytetrahydrofuran with a number-average molecular weight of 2000 were added into a reaction kettle preheated to 45° C. Stirring was started at a speed of 150 rpm, and 21.88 kg of diphenylmethane diisocyanate was added. After stirring for 5 minutes, the temperature was raised to 90° C. The reaction was carried out at 90° C. for 2 hours to obtain a prepolymer.

The prepolymer was cooled to 50° C., and 161.3 kg of dimethylacetamide (DMAc) was used to dissolve the prepolymer. Then, an amine solution with a mass concentration of 3.26%, containing 2.38 kg of ethylenediamine and 0.29 kg of diethylamine, was added, and the stirring speed was increased to 300 rpm to carry out the chain extension reaction. After the completion of the chain extension reaction, necessary additives such as antioxidants and dyeing assistants were added (the addition amount of dyeing assistant 2462B was 1%), followed by aging for 30 hours to obtain a spinning dope with a solid content of 35%. The above dope was subjected to dry spinning to obtain a polyurethane elastic fiber PUU-11 with a denier of 40D.

According to the test method described above, the mechanical property test results of the polyurethane elastic fibers (i.e., spandex filaments) obtained in Examples 12-18 and Comparative Example 1 are summarized in the table below:

| | Tensile | | | | | | |
|---|---|---|---|---|---|---|---|
| | stress at | | | | | | |
| | 300% | Tensile | Elongation | | | Plastic | |
| Spandex | elongation, | strength, | at break, | 5LP200%, | 5UP200%, | Deformation | 5UP200%/ |
| filament | cN | cN | % | cN | cN | Rate, % | 5LP200% |
| PUU-0 | 12.08 | 45.31 | 550 | 1.88 | 1.22 | 31.35 | 64. 40% |
| PUU-6 | 15.21 | 38.98 | 515 | 2.22 | 1.83 | 27.3 | 82. 40% |
| PUU-7 | 14.19 | 43.83 | 534 | 2.13 | 1.59 | 28.74 | 75.12% |
| PUU-8 | 13.92 | 42.99 | 526 | 2.09 | 1.56 | 28.86 | 74.83% |
| PUU-9 | 13.37 | 41.30 | 522 | 2.01 | 1.49 | 29.03 | 76.21% |
| PUU-10 | 13.04 | 44.39 | 546 | 1.94 | 1.29 | 31.03 | 65.83 |
| PUU-11 | 14.18 | 40.36 | 520 | 2.10 | 1.64 | 28.16 | 76.54% |

It can be seen from the above table that compared with conventional polyether-based spandex, the dyeable spandex filaments prepared by the method of the present invention show no significant decrease in mechanical properties.

According to the test method described above, the dyeing properties of the polyurethane elastic fibers (i.e., spandex filaments) obtained in Examples 12-18 and Comparative Example 1 were tested. Among them, the dyeing results with acid dyes are summarized in the table below:

| Acid | Mass of Dyed | Dye Uptake | Fixation rate |
|---|---|---|---|
| Dyeing | Filament, g | Rate, % | after soaping, % |
| PUU-0 | 1.32 | 10.68 | 5.63 |
| PUU-6 | 1.33 | 62.45 | 41.35 |
| PUU-7 | 1.31 | 31.25 | 23.25 |
| PUU-8 | 1.32 | 32.23 | 22.13 |
| PUU-9 | 1.33 | 29.25 | 20.16 |
| PUU-10 | 1.33 | 15.61 | 9.30 |
| PUU-11 | 1.34 | 43.50 | 30.21 |

The dyeing results with disperse dyes are summarized in the table below:

| Acid | Mass of Dyed | Dye Uptake | Fixation rate |
|---|---|---|---|
| Dyeing | Filament, g | Rate, % | after soaping, % |
| PUU-0 | 1.51 | 15.2 | 7.65 |
| PUU-6 | 1.53 | 56.48 | 42.65 |
| PUU-7 | 1.55 | 31.25 | 24.12 |
| PUU-8 | 1.54 | 33.13 | 23.15 |
| PUU-9 | 1.52 | 28.15 | 22.16 |
| PUU-10 | 1.51 | 20.03 | 11.94 |
| PUU-11 | 1.49 | 42.87 | 29.87 |

It can be seen from the above tables that compared with conventional polyether-based spandex, the spandex filaments prepared by the method of the present invention show a significant improvement in both dye uptake rate and color fastness for both acid dyes and disperse dyes.

According to the test method described above, the alkali resistance test results of the polyurethane elastic fibers (i.e., spandex filaments) obtained in Examples 12-18 and Comparative Example 1 are summarized in the table below:

| | Before boiling in 10g/L KOH | | | After boiling in 10g/L KOH | | |
|---|---|---|---|---|---|---|
| | alkaline solution | | | alkaline solution | | |
| | Tensile | | | Tensile | | |
| | stress at | | | stress at | | |
| | 300% | Breaking | Elongation | 300% | Breaking | Elongation |
| Spandex | elongation, | Strength, | at break, | elongation, | Strength, | at |
| filament | cN | cN | % | cN | cN | break, % |
| PUU-0 | 12.08 | 45.31 | 550 | 11.98 | 43.25 | 553.00 |
| PUU-6 | 15.21 | 38.98 | 515 | 10.25 | 31 28 | 476.00 |
| PUU-7 | 14.19 | 43.83 | 534 | 11.56 | 38.76 | 535.08 |
| PUU-8 | 13.92 | 42.99 | 526 | 11.34 | 38.01 | 524.79 |
| PUU-9 | 13.37 | 41.30 | 522 | 10.89 | 36.52 | 504.21 |
| PUU-10 | 13.04 | 44.39 | 546 | 11.71 | 42.06 | 545.00 |
| PUU-11 | 14.18 | 40.36 | 520 | 10.63 | 34.75 | 492.80 |

It can be seen from the above table that after boiling in the alkali solution, the mechanical properties of PUU-6 (which uses polyether ester polyol as the sole soft segment raw material) show partial degradation, while the mechanical properties of PUU-7 to PUU-11 (which use mixed soft segment raw materials) show little change compared with those before alkali boiling.

From the above test results, it can be concluded that compared with conventional spandex, the dyeable spandex provided by the present invention significantly improves the dye uptake rate and color fastness of the spandex filaments for both acid dyes and disperse dyes while ensuring mechanical properties. By adjusting the formula, the problem of degraded alkali resistance of spandex filaments is also avoided, and the requirements for mechanical properties, dyeability and alkali resistance of spandex filaments can be met.

1. A method for preparing polyether ester polyols, characterized by comprising the following steps:
Step 1) Adding polyether diols and polyesters as raw materials into a reaction kettle, wherein the polyesters contain an aromatic dibasic acid polyol ester structure; the polyether diols have a degree of polymerization of 2-20 and a molecular weight of 100-1000; and the molar ratio of aromatic group structures in the polyether diols to those in the polyesters is greater than 1.05:1; and
Step 2) Heating the reaction kettle to the reaction temperature to carry out a transesterification reaction, and distilling off the small-molecule polyols produced in the transesterification reaction by means of vacuum distillation to prepare the polyether ester polyols, wherein the reaction temperature is above the boiling point of the small-molecule polyols and below the boiling point of the polyether diols.

2. The method for preparing polyether ester polyols according to claim 1, characterized in that the polyether diol is one or more of polyethylene glycol, poly-1,3-propanediol, poly-1,2-propanediol, polytetrahydrofuran, polyethylene glycol-1,2-propanediol copolymer, and polytetrahydrofuran-3-methyltetrahydrofuran copolymer.

3. The method for preparing polyether ester polyols according to claim 1, characterized in that the molar ratio of aromatic group structures in the polyether diol to that in the polyester is calculated by the following formula:
R=(W+P−36)/(W−A)
wherein,
R is the molar ratio of aromatic group structures in the polyether diol to that in the polyester;
W is the molecular weight of the target polyether ester polyol, and W is 1000-5000;
P is the molecular weight of the aromatic dibasic acid in the polyester; and
A is the average molecular weight of the polyether diol.

4. A polyether ester polyol, characterized in that it comprises structures represented by the following Formula (1) and Formula (2), and terminal hydroxyl groups: 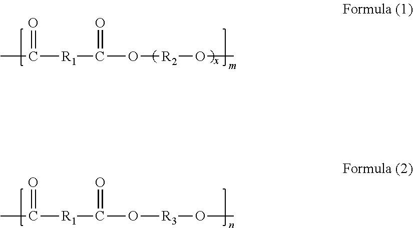
wherein R₁ is an aromatic group structure, and the mass content of R₁ in the repeating unit of Formula (1) is 4.5%-44%; R₂ is at least one of saturated alkyl groups with 2-5 carbon atoms; x is 2-20; R₃ is the residue of the polyol in the polyester raw material;
the mass ratio of Formula (2) in the structure of the polyether ester polyol is less than 20%
the number-average molecular weight of the polyether ester polyol is 1000-5000;
the average functionality of the terminal hydroxyl groups is 1.95-2.00.

5. The polyether ester polyol according to claim 4, characterized in that R₂ is at least two saturated alkyl groups with 2-5 carbon atoms.

6-15. (canceled)

16. A method for preparing polyurethane elastic fibers, non-woven fabrics, films or elastomers by means of solution processing or melt processing, comprising using the polyether ester polyol according to claim 4 as a raw material in a solution processing or melt processing procedure to produce the polyurethane elastic fibers, non-woven fabrics, films or elastomers.

17. The polyether ester polyol of claim 4, wherein the polyether ester polyol is incorporated into polyurethane elastic fibers, non-woven fabrics, films or elastomers prepared by the method according to claim 16.

18. The method of claim 16, wherein a solution processing procedure is used.

19. The method of claim 16, wherein a melt processing procedure is used.

20. The polyether ester polyol according to claim 4, wherein the mass ratio of Formula (2) in the structure of the polyether ester polyol is less than 10%.
